(19) United States
(12) Patent Application Publication
(10) Pub. No.: US 2005/0226535 A1
(43) Pub. Date: Oct. 13, 2005

(54) Method and system for rectilinearizing an image of a microarray having a non-rectilinear feature arrangement

(76) Inventor: Srinka Ghosh, San Francisco, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/823,055

(22) Filed: Apr. 13, 2004

(51) Int. Cl. G06K 9/36; G06K 9/00

(52) U.S. Cl. 382/294; 382/128

(57) ABSTRACT

A method and system for rectilinearizing an image of a double-density, microarray having a non-rectilinear, outermost feature-position arrangement. In a disclosed embodiment, an image of a microarray having a non-rectilinear, outermost, feature-position arrangement is obtained from the signal intensity data of a microarray of features. A coordinate scheme of horizontal and vertical grid lines is superimposed on the image in order to assign a coordinate location to each feature of the microarray. Three corner features of the microarray are selected and used to determine one or more feature positions to add to the non-rectilinear, outermost, feature-position arrangement to form a rectilinear, outermost, feature-position arrangement of the microarray features.

Embodiments of the present invention are related to data extraction from images of microarrays and, in particular, to a general method and system for rectilinearizing a double-density microarray having a non-rectilinear, outermost, feature-position arrangement.

### BACKGROUND OF THE INVENTION

The present invention is related to microarrays. In order to facilitate discussion of the present invention, a general background for microarrays and examples of their use is provided below. In the following discussion, the terms “microarray,” “molecular array,” and “array” are used interchangeably. The terms “microarray” and “molecular array” are well known and well understood in the scientific community. As discussed below, a microarray is a precisely manufactured tool which may be used in research, diagnostic testing, or various other analytical techniques.

Microarray technologies have gained prominence in biological research and in diagnostics. Currently, microarray techniques are most often used to determine the concentrations of particular nucleic-acid polymers in complex sample solutions. Microarray-based analytical techniques are not, however, restricted to analysis of nucleic acid solutions, but may be employed to analyze complex solutions of any type of molecule that can be optically or radiometrically scanned and that can bind with high specificity to complementary molecules synthesized within, or bound to, discrete features on the surface of a microarray. Because microarrays are widely used for analysis of nucleic acid samples, the following background information on microarrays is introduced in the context of analysis of nucleic acid solutions following a brief background of nucleic acid chemistry.

Deoxyribonucleic acid (“DNA”) and ribonucleic acid (“RNA”) are linear polymers, each synthesized from four different types of subunit molecules. FIG. 1 illustrates a short DNA polymer 100, called an oligomer, composed of the following subunits: (1) deoxy-adenosine 102; (2) deoxy-thymidine 104; (3) deoxy-cytosine 106; and (4) deoxy-guanosine 108. When phosphorylated, subunits of DNA and RNA molecules are called “nucleotides” and are linked together through phosphodiester bonds 110-115 to form DNA and RNA polymers. A linear DNA molecule, such as the oligomer shown in FIG. 1, has a 5′ end 118 and a 3′ end 120. A DNA polymer can be chemically characterized by writing, in sequence from the 5′ end to the 3′ end, the single letter abbreviations A, T, C, and G for the nucleotide subunits that together compose the DNA polymer. For example, the oligomer 100 shown in FIG. 1 can be chemically represented as “ATCG.”

The DNA polymers that contain the organization information for living organisms occur in the nuclei of cells in pairs, forming double-stranded DNA helixes. One polymer of the pair is laid out in a 5′ to 3′ direction, and the other polymer of the pair is laid out in a 3′ to 5′ direction, or, in other words, the two strands are anti-parallel. The two DNA polymers, or strands, within a double-stranded DNA helix are bound to each other through attractive forces including hydrophobic interactions between stacked purine and pyrimidine bases and hydrogen bonding between purine and pyrimidine bases, the attractive forces emphasized by conformational constraints of DNA polymers. Because of a number of chemical and topographic constraints, double-stranded DNA helices are most stable when deoxy-adenylate subunits of one strand hydrogen bond to deoxy-thymidylate subunits of the other strand, and deoxy-guanylate subunits of one strand hydrogen bond to corresponding deoxy-cytidilate subunits of the other strand. FIGS. 2A-B illustrates the hydrogen bonding between the purine and pyrimidine bases of two anti-parallel DNA strands. AT and GC base pairs, illustrated in FIGS. 2A-B, are known as Watson-Crick (“WC”) base pairs. Two DNA strands linked together by hydrogen bonds forms the familiar helix structure of a double-stranded DNA helix. FIG. 3 illustrates a short section of a DNA double helix 300 comprising a first strand 302 and a second, anti-parallel strand 304. Although deoxy-guanylate subunits of one strand are generally paired with deoxy-cytidilate subunits from the other strand, and deoxy-thymidilate subunits in one strand are generally paired with deoxy-adenylate subunits from the other strand, non-WC base pairings may occur within double-stranded DNA.

Double-stranded DNA may be denatured, or converted into single stranded DNA, by changing the ionic strength of the solution containing the double-stranded DNA or by raising the temperature of the solution. Single-stranded DNA polymers may be renatured, or converted back into DNA duplexes, by reversing the denaturing conditions, for example by lowering the temperature of the solution containing complementary single-stranded DNA polymers. During renaturing or hybridization, complementary bases of anti-parallel DNA strands form WC base pairs in a cooperative fashion, leading to reannealing of the DNA duplex.

The ability to denature and renature double-stranded DNA has led to the development of many extremely powerful and discriminating assay technologies for identifying the presence of DNA and RNA polymers having particular base sequences or containing particular base subsequences within complex mixtures of different nucleic acid polymers, other biopolymers, and inorganic and organic chemical compounds. FIGS. 4-7 illustrate the principle of the microarray-based hybridization assay. A microarray (402 in FIG. 4) comprises a substrate upon which a regular pattern of features is prepared by various manufacturing processes. The microarray 402 in FIG. 4, and in subsequent FIGS. 5-7, has a grid-like 2-dimensional pattern of square features, such as feature 404 shown in the top, left-hand corner of the microarray. Each feature of the microarray contains a large number of identical oligonucleotides covalently bound to the surface of the feature. These bound oligonucleotides are known as probes. In general, chemically distinct probes are bound to the different features of an microarray, so that each feature corresponds to a particular nucleotide sequence.

Once a microarray has been prepared, the microarray may be exposed to a sample solution of target DNA or RNA molecules (410-413 in FIG. 4) labeled with fluorophores, chemiluminescent compounds, or radioactive atoms 415-418. Labeled target DNA or RNA hybridizes through base pairing interactions to the complementary probe DNA, synthesized on the surface of the microarray. FIG. 5 shows a number of such target molecules 502-504 hybridized to complementary probes 505-507, which are in turn bound to the surface of the microarray 402. Targets, such as labeled DNA molecules 508 and 509, that do not contain nucleotide sequences complementary to any of the probes bound to microarray surface do not hybridize to generate stable duplexes and, as a result, tend to remain in solution. The sample solution is then rinsed from the surface of the microarray, washing away any unbound-labeled DNA molecules. In other embodiments, unlabeled target sample is allowed to hybridize with the microarray first. Typically, such a target sample has been modified with a chemical moiety that will react with a second chemical moiety in subsequent steps. Then, either before or after a wash step, a solution containing the second chemical moiety bound to a label is reacted with the target on the microarray. After washing, the microarray is ready for scanning. Biotin and avidin represent an example of a pair of chemical moieties that can be utilized for such steps.

As shown in FIG. 6, the bound labeled DNA molecules are detected via optical or radiometric scanning. Optical scanning involves exciting labels of bound labeled DNA molecules with electromagnetic radiation of appropriate frequency and detecting fluorescent emissions from the labels, or detecting light emitted from chemiluminescent labels. When radioisotope labels are employed, radiometric scanning can be used to detect the signal emitted from the hybridized features. Additional types of signals are also possible, including electrical signals generated by electrical properties of bound target molecules, magnetic properties of bound target molecules, and other such physical properties of bound target molecules that can produce a detectable signal. Optical, radiometric, or other types of scanning produce an analog or digital representation of the microarray as shown in FIG. 7, with features to which labeled target molecules are hybridized similar to 706 optically or digitally differentiated from those features to which no labeled DNA molecules are bound. Features displaying positive signals in the analog or digital representation indicate the presence of DNA molecules with complementary nucleotide sequences in the original sample solution. Moreover, the signal intensity produced by a feature is generally related to the amount of labeled DNA bound to the feature, in turn related to the concentration, in the sample to which the microarray was exposed, of labeled DNA complementary to the oligonucleotide within the feature.

When a microarray is scanned or otherwise analyzed, data may be collected as a two-dimensional digital image of the microarray, each pixel of which represents the intensity of phosphorescent, fluorescent, chemiluminescent, or radioactive emission from an area of the microarray corresponding to the pixel. A microarray data set may comprise a two-dimensional image or a list of numerical or alphanumerical pixel intensities, or any of many other computer-readable data sets. An initial series of steps employed in processing digital microarray images includes constructing a regular coordinate system for the digital image of the microarray by which the features within the digital image of the microarray can be indexed and located. For example, when the features are laid out in a periodic, rectilinear pattern, a rectilinear coordinate system is commonly constructed so that the positions of the centers of features lie as closely as possible to intersections between horizontal and vertical gridlines of the rectilinear coordinate system, alternatively, exactly half-way between a pair of adjacent horizontal and a pair of adjacent vertical grid lines. Then, regions of interest (“ROIs”) are computed, based on the initially estimated positions of the features in the coordinate grid, and centroids for the ROIs are computed in order to refine the positions of the features. Once the position of a feature is refined, feature pixels can be differentiated from background pixels within the ROI, and the signal corresponding to the feature can then be computed by integrating the intensity over the feature pixels.

Scanning of a microarray by an optical scanning device or radiometric scanning device generally produces an image comprising a rectilinear grid of pixels, with each pixel having a corresponding signal intensity. These signal intensities are processed by an microarray-data-processing program that analyzes data scanned from an microarray to produce experimental or diagnostic results which are stored in a computer-readable medium, transferred to an intercommunicating entity via electronic signals, printed in a human-readable format, or otherwise made available for further use. Microarray experiments can indicate precise gene-expression responses of organisms to drugs, other chemical and biological substances, environmental factors, and other effects. Microarray experiments can also be used to diagnose disease, for gene sequencing, and for analytical chemistry. Processing of microarray data can produce detailed chemical and biological analyses, disease diagnoses, and other information that can be stored in a computer-readable medium, transferred to an intercommunicating entity via electronic signals, printed in a human-readable format, or otherwise made available for further use.

The microarrays illustrated in FIGS. 4-7 show a regularly spaced two-dimensional matrix or microarray features. However, the microarray features may be arranged to cover the surface of the microarray at higher densities, as, for example, by offsetting the features in adjacent rows to produce a more densely-packed arrangement of features. FIGS. 8A-B illustrate two types of arrangements of densely-packed, disk-shaped microarray features. FIG. 8A shows a densely-packed microarray having a rectangular, outermost, feature-position arrangement denoted by shaded features 801. FIG. 8B shows a densely-packed microarray having a non-rectangular, outermost, feature-position arrangement denoted by shaded features 802. A microarray having a rectangular, outermost, feature-position arrangement is referred to as “rectilinear,” and a microarray having a non-rectangular, outermost, feature-position arrangement is referred to as “non-rectilinear.”

Many currently available programs that extract feature information from scanned or otherwise analyzed images of microarrays rely on a rectilinear, outermost, feature-position arrangement in order to generate an initial, or seed, location for each feature. Attempts to extract data from microarrays with non-rectilinear, outermost feature boundaries by current feature extraction programs often result in errors. Therefore, designers, manufacturers, and users of microarrays have recognized a need for a method and system to enable extraction of data from microarrays having non-rectilinear, outermost feature boundaries.

### SUMMARY OF THE INVENTION

One embodiment of the present invention comprises a method and system for rectilinearizing a double-density, non-rectilinear microarray of features within a scanned or otherwise analyzed image of a microarray. A feature-coordinate grid of horizontal and vertical grid lines is superimposed over the microarray image so that the center of each feature of the microarray image coincides with a unique intersection of a horizontal and vertical grid line. Three corner features are selected and indexed. The coordinates of the three selected corner features are used to determine three feature positions defining three corners of a rectilinear, outermost, feature-position arrangement of the non-rectilinear microarray of features. A fourth feature position of the rectilinear, outermost, feature-position arrangement is determined from two of the three feature positions.

### BRIEF DESCRIPTION OF THE DRAWINGS

FIG. 1 illustrates a short DNA polymer.

FIGS. 2A-B illustrate the hydrogen bonding between the purine and pyrimidine bases of two anti-parallel DNA strands.

FIG. 3 illustrates a short section of a DNA double helix comprising a first strand and a second, anti-parallel strand.

FIG. 4 illustrates a grid-like, two-dimensional pattern of square features.

FIG. 5 shows a number of target molecules hybridized to complementary probes, which are in turn bound to the surface of the microarray.

FIG. 6 illustrates the bound labeled DNA molecules detected via optical or radiometric scanning.

FIG. 7 illustrates optical, radiometric, or other types of scanning produced by an analog or digital representation of the microarray.

FIGS. 8A-B illustrate two types of arrangements of densely-packed, disk- shaped microarray features.

FIG. 9 is a control-flow diagram of a rectilinearization method that represents one embodiment of the present invention.

FIG. 10 illustrates the orientation of a double-density, hypothetical microarray having a non-rectilinear, outermost feature arrangement.

FIG. 11 shows the two rectilinear lattices of features of the hypothetical microarray shown in FIG. 10.

FIG. 12 shows three example selected corner features of a hypothetical microarray.

FIG. 13 illustrates the assignment of coordinates to the features of a scanned or otherwise analyzed image of a microarray that represents one embodiment of the present invention.

FIG. 14 shows the selected corner features F_{Corner}_{_{—}}_{index} and the corresponding points L₁C_{Corner}_{_{—}}_{index} and L₂C_{Corner}_{_{—}}_{index} of a hypothetical microarray.

FIG. 15 is an illustration of the selected corner features F_{Corner}_{_{—}}_{index}, the points L₁C_{Corner}_{_{—}}_{index} and L₂C_{Corner}_{index}, and lattices L₁ and L₂ of a hypothetical microarray.

FIG. 16 is an illustration of three of the four feature positions defining a rectilinear, outermost, feature-position arrangement for a hypothetical microarray.

FIG. 17 is an illustration of two orthogonal vectors defining a rectilinear, outermost, feature-position arrangement of a hypothetical microarray.

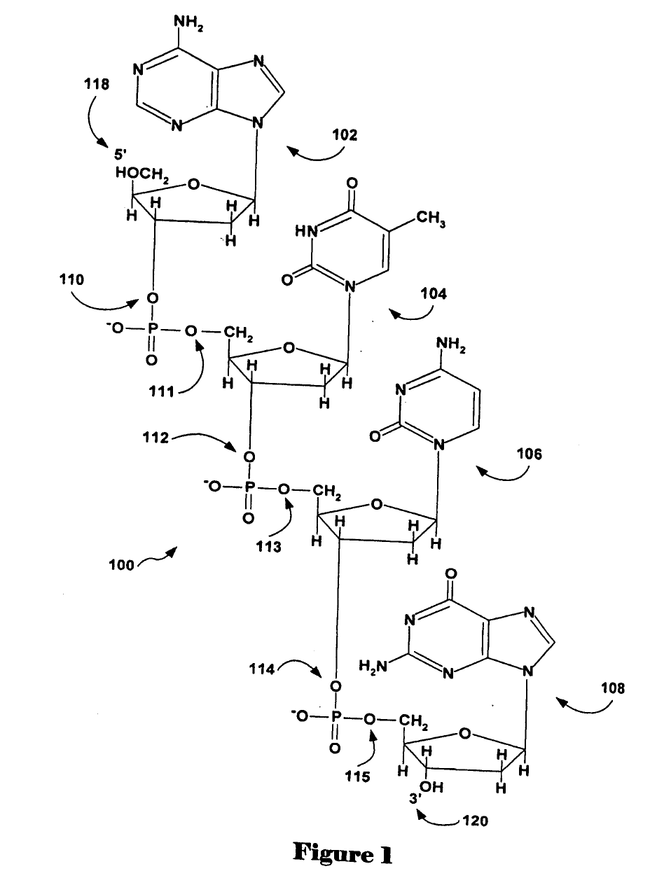

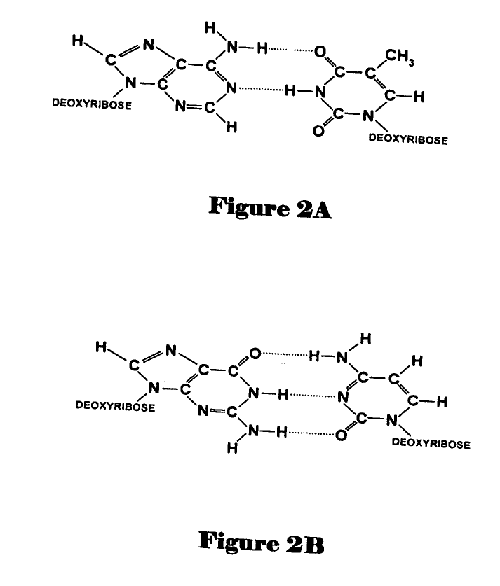

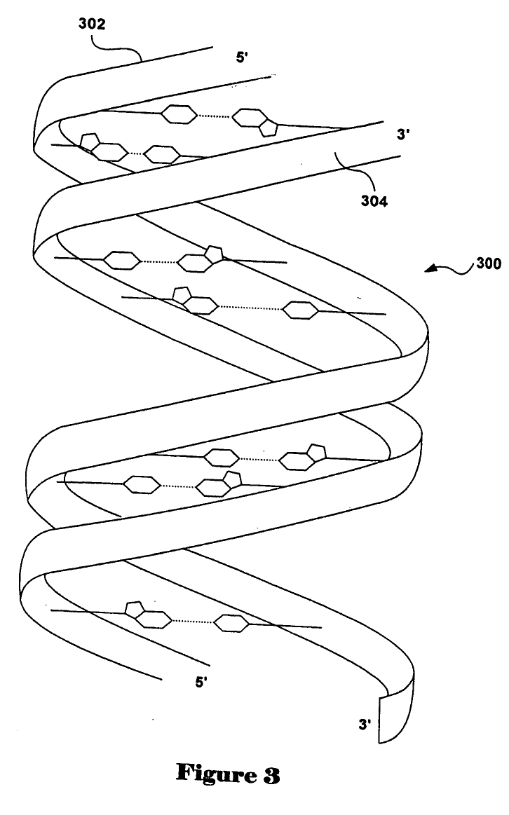

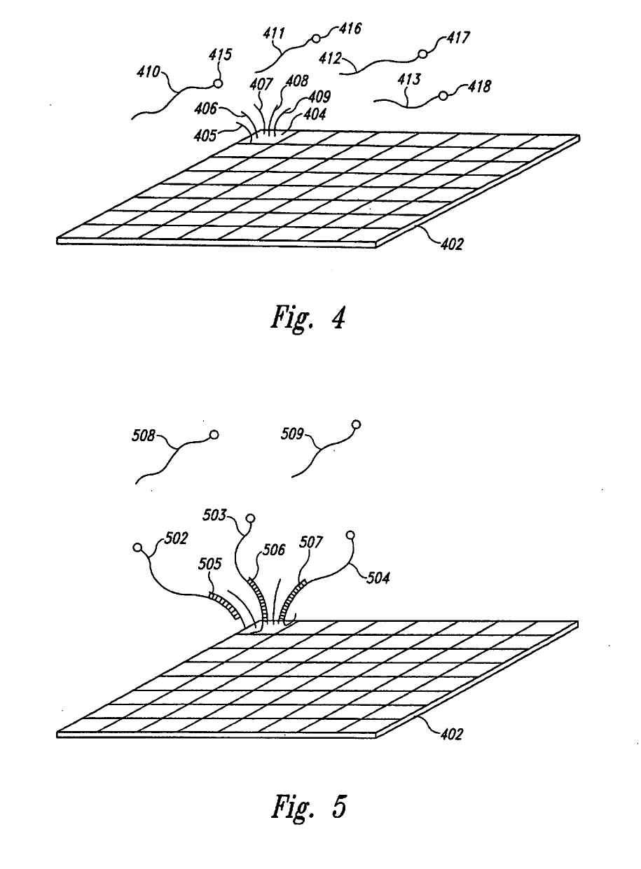

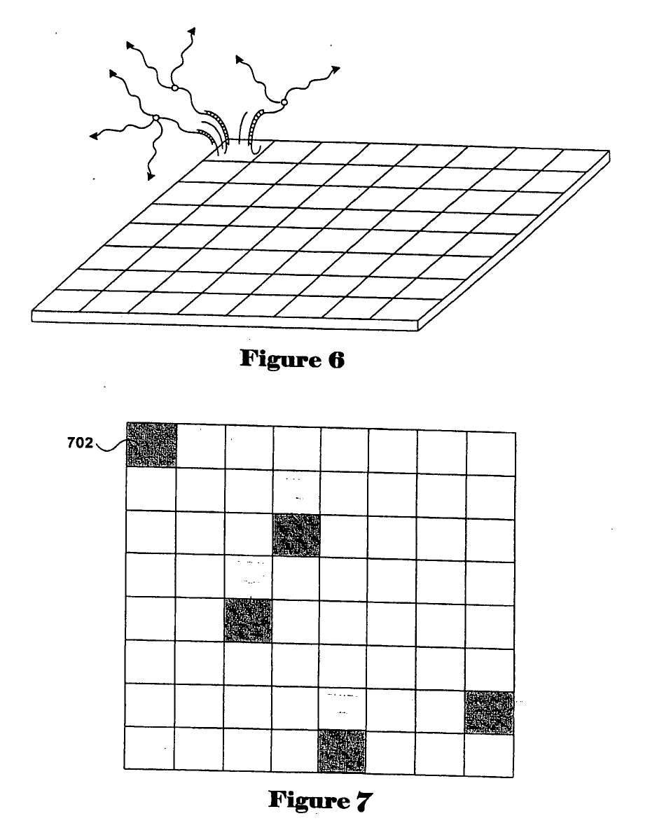

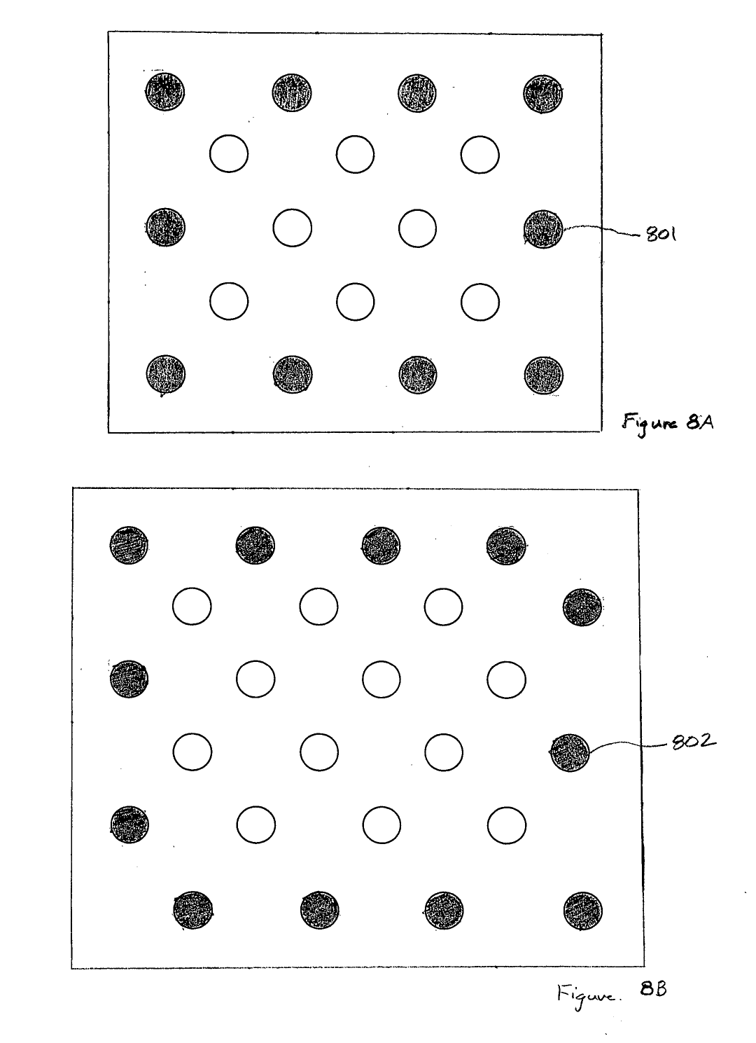

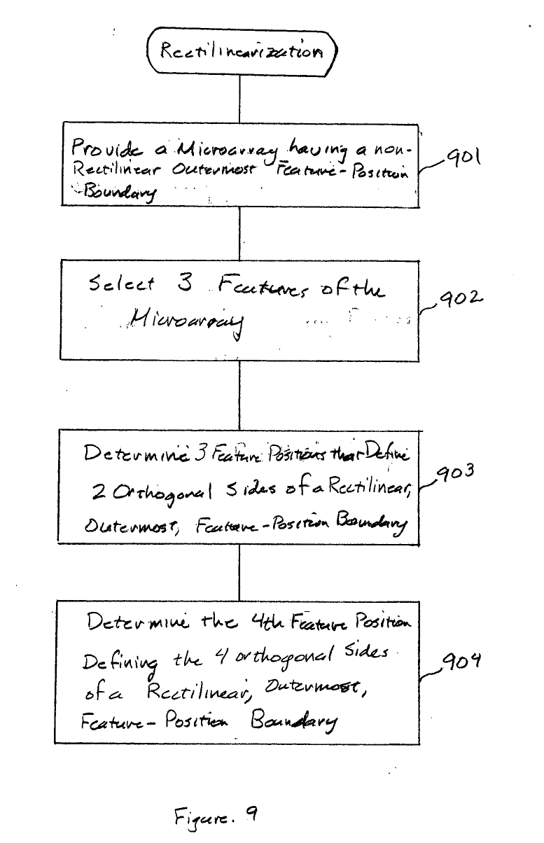

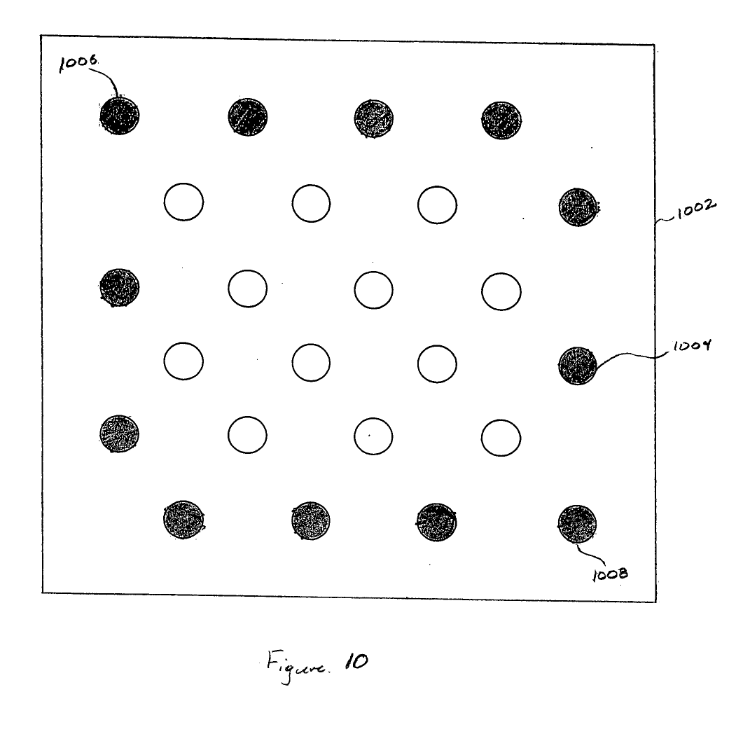

### DETAILED DESCRIPTION OF THE INVENTION

The present invention is directed toward a method and system for rectilinearizing a scanned or otherwise analyzed image of a non-rectilinear grid of microarray features. FIG. 9 is a control-flow diagram of a rectilinearization method that represents one embodiment of the present invention. First, in step 901, an image of a microarray having a non-rectilinear, outermost, feature-position arrangement is provided. Next, in step 902, three corner features of the microarray of features are selected. Next, in step 903, the coordinates of the three selected corner features are used to determine three feature positions defining two orthogonal sides of a rectilinear, outermost, feature-position arrangement of the microarray features. Finally, in step 904, a fourth feature position is determined from the coordinates of two of the three feature positions determined in step 903 to complete the rectilinear, outermost, feature-position arrangement.

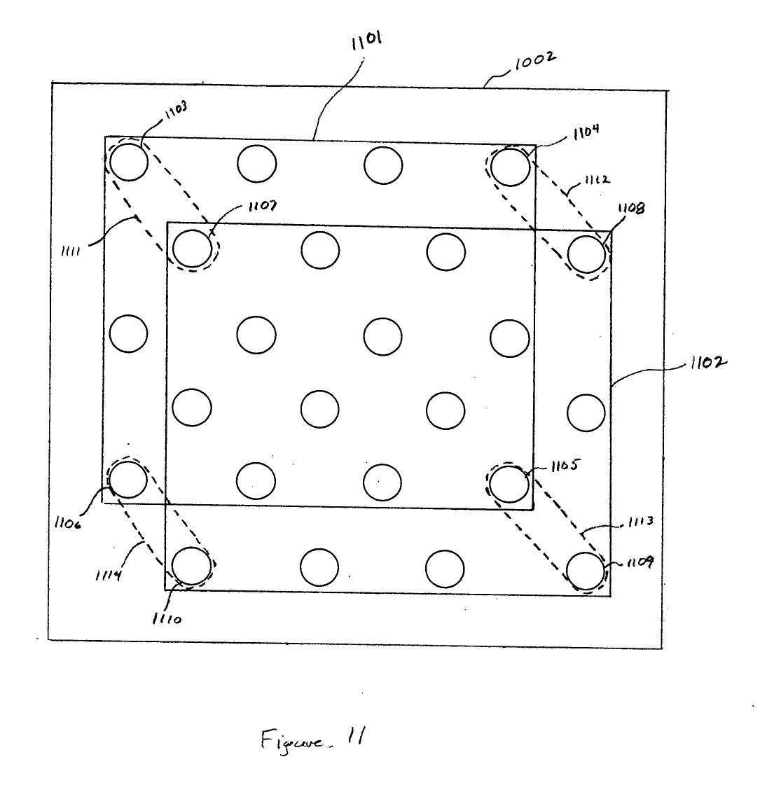

The following discussion includes two subsections, a first subsection including additional information about molecular arrays, and a second subsection describing embodiments of the present invention with reference to FIGS. 10-17.

### Additional Information About Microarrays

An array may include any one-, two- or three-dimensional arrangement of addressable regions, or features, each bearing a particular chemical moiety or moieties, such as biopolymers, associated with that region. Any given array substrate may carry one, two, or four or more arrays disposed on a front surface of the substrate. Depending upon the use, any or all of the arrays may be the same or different from one another and each may contain multiple spots or features. A typical array may contain more than ten, more than one hundred, more than one thousand, more ten thousand features, or even more than one hundred thousand features, in an area of less than 20 cm² or even less than 10 cm². For example, square features may have widths, or round feature may have diameters, in the range from a 10 μm to 1.0 cm. In other embodiments each feature may have a width or diameter in the range of 1.0 μm to 1.0 mm, usually 5.0 μm to 500 μm, and more usually 10 μm to 200 μm. Features other than round or square may have area ranges equivalent to that of circular features with the foregoing diameter ranges. At least some, or all, of the features may be of different compositions (for example, when any repeats of each feature composition are excluded the remaining features may account for at least 5%, 10%, or 20% of the total number of features). Inter-feature areas are typically, but not necessarily, present. Inter-feature areas generally do not carry probe molecules. Such inter-feature areas typically are present where the arrays are formed by processes involving drop deposition of reagents, but may not be present when, for example, photolithographic array fabrication processes are used. When present, interfeature areas can be of various sizes and configurations.

Each array may cover an area of less than 100 cm², or even less than 50 cm^{2,} 10 cm² or 1 cm². In many embodiments, the substrate carrying the one or more arrays will be shaped generally as a rectangular solid having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. Other shapes are possible, as well. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, a substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulsejets of either polynucleotide precursor units (such as monomers) in the case of in situ fabrication, or the previously obtained polynucleotide. Such methods are described in detail in, for example, U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, photolithographic array fabrication methods may be used. Interfeature areas need not be present particularly when the arrays are made by photolithographic methods as described in those patents.

A molecular array is typically exposed to a sample including labeled target molecules, or, as mentioned above, to a sample including unlabeled target molecules followed by exposure to labeled molecules that bind to unlabeled target molecules bound to the array, and the array is then read. Reading of the array may be accomplished by illuminating the array and reading the location and intensity of resulting fluorescence at multiple regions on each feature of the array. For example, a scanner may be used for this purpose, which is similar to the AGILENT MICROARRAY SCANNER manufactured by Agilent Technologies, Palo Alto, Calif. Other suitable apparatus and methods are described in published U.S. patent applications 20030160183A1, 20020160369A1, 20040023224A1, and 20040021055A, as well as U.S. Pat. No. 6,406,849. However, arrays may be read by any other method or apparatus than the foregoing, with other reading methods including other optical techniques, such as detecting chemiluminescent or electroluminescent labels, or electrical techniques, for where each feature is provided with an electrode to detect hybridization at that feature in a manner disclosed in U.S. Pat. No. 6,251,685, and elsewhere.

A result obtained from reading an array, followed by application of a method of the present invention, may be used in that form or may be further processed to generate a result such as that obtained by forming conclusions based on the pattern read from the array, such as whether or not a particular target sequence may have been present in the sample, or whether or not a pattern indicates a particular condition of an organism from which the sample came. A result of the reading, whether further processed or not, may be forwarded, such as by communication, to a remote location if desired, and received there for further use, such as for further processing. When one item is indicated as being remote from another, this is referenced that the two items are at least in different buildings, and may be at least one mile, ten miles, or at least one hundred miles apart. Communicating information references transmitting the data representing that information as electrical signals over a suitable communication channel, for example, over a private or public network. Forwarding an item refers to any means of getting the item from one location to the next, whether by physically transporting that item or, in the case of data, physically transporting a medium carrying the data or communicating the data.

As pointed out above, array-based assays can involve other types of biopolymers, synthetic polymers, and other types of chemical entities. A biopolymer is a polymer of one or more types of repeating units. Biopolymers are typically found in biological systems and particularly include polysaccharides, peptides, and polynucleotides, as well as their analogs such as those compounds composed of, or containing, amino acid analogs or non-amino-acid groups, or nucleotide analogs or non-nucleotide groups. This includes polynucleotides in which the conventional backbone has been replaced with a non-naturally occurring or synthetic backbone, and nucleic acids, or synthetic or naturally occurring nucleic-acid analogs, in which one or more of the conventional bases has been replaced with a natural or synthetic group capable of participating in Watson-Crick-type hydrogen bonding interactions. Polynucleotides include single or multiple-stranded configurations, where one or more of the strands may or may not be completely aligned with another. For example, a biopolymer includes DNA, RNA, oligonucleotides, and PNA and other polynucleotides as described in U.S. Pat. No. 5,948,902 and references cited therein, regardless of the source. An oligonucleotide is a nucleotide multimer of about 10 to 100 nucleotides in length, while a polynucleotide includes a nucleotide multimer having any number of nucleotides.

As an example of a non-nucleic-acid-based molecular array, protein antibodies may be attached to features of the array that would bind to soluble labeled antigens in a sample solution. Many other types of chemical assays may be facilitated by array technologies. For example, polysaccharides, glycoproteins, synthetic copolymers, including block copolymers, biopolymer-like polymers with synthetic or derivitized monomers or monomer linkages, and many other types of chemical or biochemical entities may serve as probe and target molecules for array-based analysis. A fundamental principle upon which arrays are based is that of specific recognition, by probe molecules affixed to the array, of target molecules, whether by sequence-mediated binding affinities, binding affinities based on conformational or topological properties of probe and target molecules, or binding affinities based on spatial distribution of electrical charge on the surfaces of target and probe molecules.

Scanning of a molecular array by an optical scanning device or radiometric scanning device generally produces an image comprising a rectilinear grid of pixels, with each pixel having a corresponding signal intensity. These signal intensities are processed by an array-data-processing program that analyzes data scanned from an array to produce experimental or diagnostic results which are stored in a computer-readable medium, transferred to an intercommunicating entity via electronic signals, printed in a human-readable format, or otherwise made available for further use. Molecular array experiments can indicate precise gene-expression responses of organisms to drugs, other chemical and biological substances, environmental factors, and other effects. Molecular array experiments can also be used to diagnose disease, for gene sequencing, and for analytical chemistry. Processing of molecular-array data can produce detailed chemical and biological analyses, disease diagnoses, and other information that can be stored in a computer-readable medium, transferred to an intercommunicating entity via electronic signals, printed in a human-readable format, or otherwise made available for further use.

### Embodiments of the Present Invention

One embodiment of the method of the present invention is described by applying the method to an example hypothetical microarray having a double-density, non-rectilinear, outermost, feature-position arrangement. FIG. 10 illustrates the orientation of the densely-packed, hypothetical microarray 1002 having a non-rectilinear, outermost, feature-position arrangement. The densely-packed microarray shown in FIG. 10 may also be referred to as a “double-density” microarray. The non-rectilinear, outermost, feature-position arrangement of the hypothetical microarray 1002 is denoted by shaded features 1004. The microarray 1002 is oriented so that corner features 1006 and 1008 of the outermost, feature-position arrangement of features 1004 are located in the top, left-hand corner and the bottom, right-hand corner of the microarray, respectively.

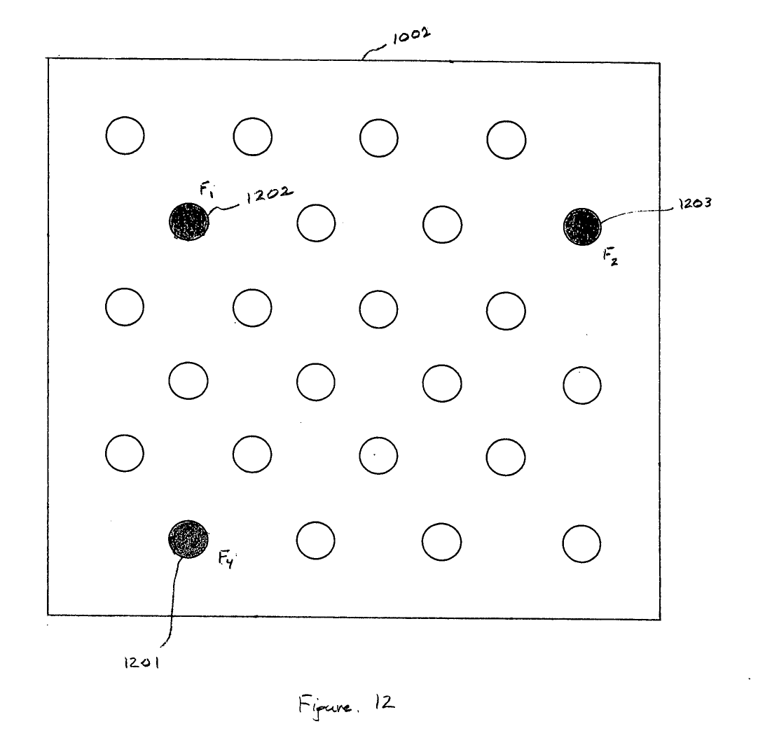

Three features of the microarray are selected from the corner features of two rectilinear lattices of the hypothetical microarray 1002. FIG. 11 shows the two rectilinear lattices 1101 and 1102, referred to as “L₁,” and “L₂, respectively, of the hypothetical microarray 1002. The three features are selected from the corner features 1103-1106 of lattice L₁ 1101 and the corner features 1107-1110 of lattice L₂ 1102. The corner features are determined by choosing one feature from each of three of the four pairs 1111-1114 of two corner features. For example, the first corner feature can be selected from any one of the four pairs 1111-1114. The second corner feature can be selected from any of the three pairs not already used in the selection of the first corner feature. Finally, the third corner feature can be selected from the two remaining pairs not already used in the selection of the first and second corner features.

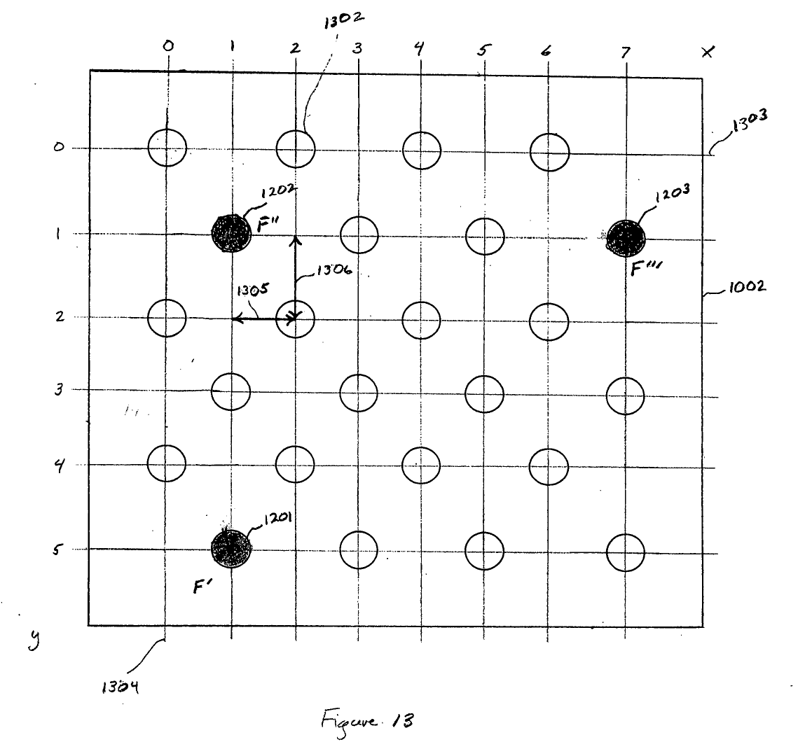

After the three corner features have been selected, the selected corner features are indexed 1, 2, 3, or 4. In the present example, the indexes are assigned in a clockwise manner beginning with assigning the index value 1 to the selected corner feature located in the top, left-hand corner the microarray 1002, as denoted by pair 1111, and ending with assigning the index value 4 to the selected corner feature located in the bottom, left-hand corner of the microarray, as denoted by pair 1114. The selected corner features are referred to as “F_{Corner}_{_{—}}_{index},” where the subscript Corner_index is assigned the integer value 1, 2, 3, or 4 associated with the corners of the lattices L₁ and L₂. FIG. 12 shows three example selected corner features F₄ 1201, F₁ 1202, and F₂ 1202 of the hypothetical microarray 1002. Note that the present invention is not limited to selecting the three selected corner features having the subscript Corner_index equal to 4, 2, 1, as shown in FIG. 12. Different possible selected corner features for Corner_index equal to 1, 2, 3; or 2, 3, 4; or 4, 3, 1 can also be selected.

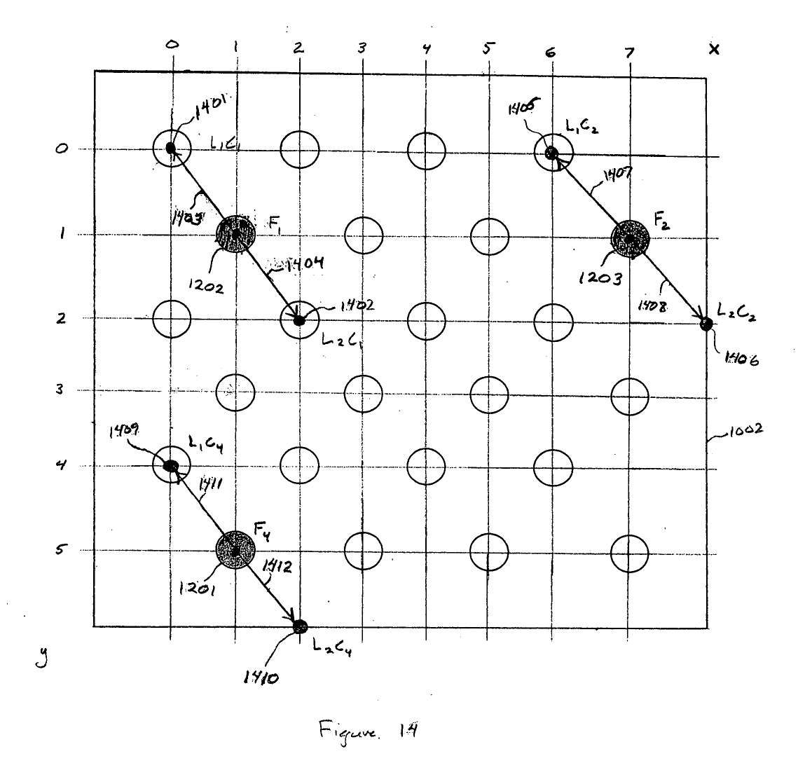

In order to rectilinearize a microarray having a non-rectilinear, outermost, feature-position arrangement, a feature-coordinate grid identifying the centroid coordinates of each feature of the microarray is needed. FIG. 13 illustrates the assignment of coordinates, to the features of an image of a microarray, that represents one of many possible embodiments of the present invention. FIG. 13 illustrates the assignment of coordinates of a feature-coordinate grid to an image of the hypothetical microarray 1002. A set of horizontal and vertical grid lines, such as horizontal line 1303 and vertical line 1304, are superimposed on the image of the microarray so that the vertical and horizontal grid line intersections coincide as closely as possible with the centers of microarray features to give a regularly spaced feature-coordinate grid. The distance 1305 between the vertical grid lines is referred to as “offset_x,” and the distance 1306 between the horizontal grid lines is referred to as “offset_y.” The feature-coordinate grid establishes a two-dimensional system for specifying the location of each microarray feature. Thus, for example, the location of feature 1302 can be specified by the grid-point indices (2, 0).

Next, the x and y coordinates of each of the three selected corner features F_{Corner}_{_{—}}_{index} are used to determine the coordinates of the two points L₁C_{Corner}_{_{—}}_{index} and L₂C_{Corner}_{_{—}}_{index} for each of the selected corner features according to the following expressions:
L₁C_{Corner}_{_{—}}_{index—}x=F_{Corner}_{_{—}}_{index—}x−offset_{—}x (1)
L₁C_{Corner}_{_{—}}_{index—}y=F_{Corner}_{_{—}}_{index—}y−offset_{—}y (2)
L₂C_{Corner}_{_{—}}_{index—}x=F_{Corner}_{_{—index—}}x−offset_{—}x (3)
L₂C_{Corner}_{_{—}}_{index—}y=F_{Corner}_{_{—}}_{index—}y−offset_{—}y (4)
where L₁C_{Corner}_{_{—index}}_{_{—}}x and L₁C_{Corner}_{_{—}}_{index}_{_{—}}y are the x and y coordinates of the point L₁C_{Corner}_{_{—}}_{index}, respectively, L₂C_{Corner}_{_{—}}_{index}_{_{—}}x and L₂C_{Corner}_{_{—}}_{index}_{_{—}}y are the x and y coordinates of the point L₂C_{Corner}_{_{—}}_{index}, respectively, and F_{Corner}_{_{—}}_{index}_{_{—}}x and F_{Corner}_{_{—}}_{index}_{_{—}}y are the x and y coordinates of the selected corner feature F_{Corner}_{_{—index}}.

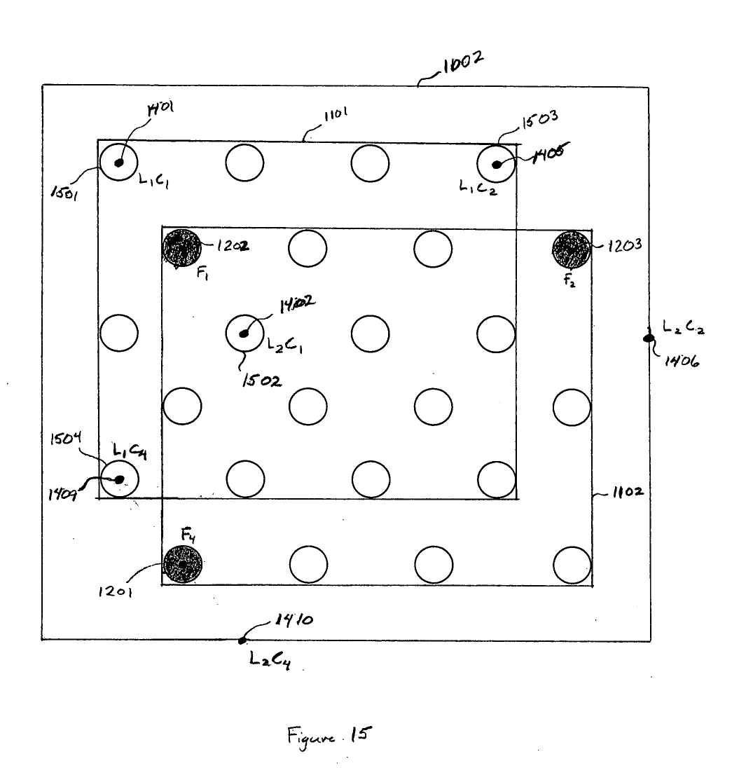

FIG. 14 shows the selected corner features F_{Corner}_{_{—}}_{index} and the corresponding points L₁C_{Corner}_{_{—}}_{index} and L₂C_{Corner}_{_{—}}_{index} determined according to equations (1) through (4) for the hypothetical microarray 1002. The centroid coordinates of corner feature F₁ 1202 are used to determine the points L₁C₁ 1401 and L₂C₁ 1402, as indicated by arrows 1403 and 1404, respectively. The centroid coordinates of feature F₂ 1203 are used to determine the points L₁C₂ 1405 and L₂C₂ 1406, as indicated by arrows 1407 and 1408, respectively. Finally, the centroid coordinates of corner feature F₄ 1201 are used to determine the points L₁C₄ 1409 and L₂C₄ 1410, as indicated by edges 1411 and 1412, respectively.

Next, the selected corner features F_{Corner}_{_{—}}_{index} are determined to be either a member of lattice L₁ or L₂ according the following four conditions:

(1) For selected corner feature F₁, if each of the points L₁C₁ and L₂C₁ coincide with features of the microarray, then selected corner feature F₁ is a corner feature of lattice L₂. If L₁C₁ does not coincide with a feature of the microarray, and L₂C₁ coincides with a feature of the microarray, then selected corner feature F₁ is a corner feature of lattice L₁.

(2) For selected corner feature F₂, if the point L₁C₂ coincides with a feature of the microarray, and L₂C₂ does not coincides with any features of the microarray, then selected corner feature F₂ is a corner feature of lattice L₂. If L₁C₂ does not coincide with a feature of the microarray, and L₂C₂ coincides with a feature of the microarray, then selected corner feature F₂ is a corner feature of lattice L₁.

(3) For selected corner feature F₃, if each of the points L₁C₃ and L₂C₃ coincide with features of the microarray, then selected corner feature F₃ is a corner feature of lattice L₁. If L₁C₃ coincides with a feature of the microarray, and L₂C₃ does not coincides with a feature of the microarray, then selected corner feature F₃ is a corner feature of lattice L₂.

(4) For selected corner feature F₄, if the point L₁C₄ coincides with a feature of the microarray grid, and L₂C₄ does not coincides with any features of the microarray, then selected corner feature F₄ is a corner feature of lattice L₂. If L₁C₄ does not coincide with a feature of the microarray, and L₂C₄ coincides with a feature of the microarray, then selected corner feature F₄ is a corner feature of lattice L₁.

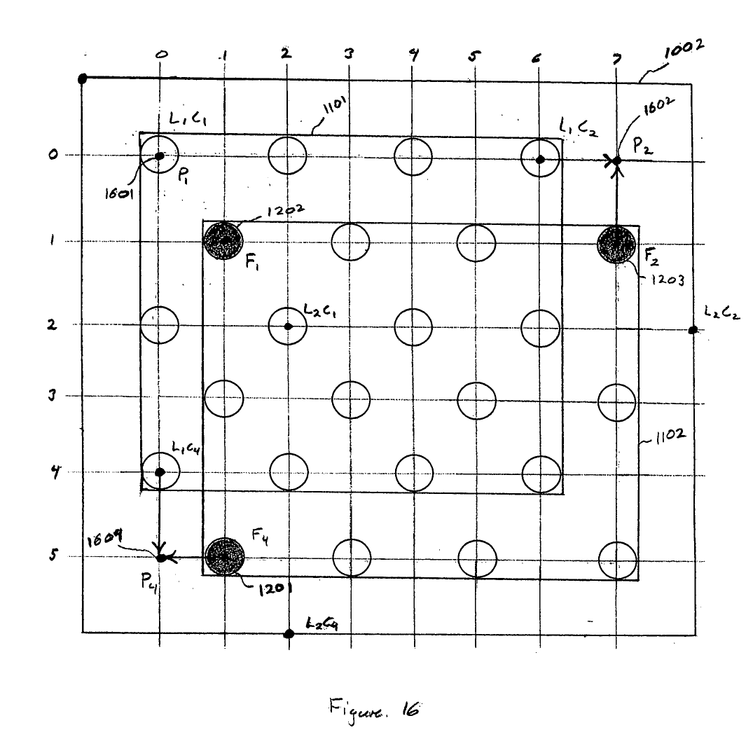

FIG. 15 is an illustration of the hypothetical selected corner features F_{Corner}_{_{—}}_{index}, the points L₁C_{Corner}_{_{—}}_{index} and L₂C_{Corner}_{_{—}}_{index}, and lattices L₁ and L₂ of the hypothetical microarray 1002. The points L₁C₁ 1401 and L₂C₁ 1402 coincide with features 1501 and 1502, therefore, according to condition (1), selected corner feature F₁ 1202 is a corner feature of lattice L₂ 1102. The point L₁C₂ 1405 coincides with feature 1403, and the point L₂C₂ 1406 does not coincide with any features of the microarray, therefore, according to condition (2), the selected corner feature F₂ 1203 is a corner feature of lattice L₂ 1102. Finally, the point L₁C₄ 1409 coincides with the feature 1504, and the point L₂C₄ 1420 does not coincide with any feature of the microarray, therefore, according to condition (4), the selected corner feature F₄ 1201 is a corner feature of lattice L₂ 1102.

Next, the coordinates of three of the four feature positions defining the four corner features of the rectilinear, outermost, feature-position arrangement of the microarray of features are determined. The feature positions defining the four corner features of a derived, outermost, rectilinear arrangement are referred to as “P_{Corner}_{_{—}}_{index},” where the values of the subscript Corner_index is assigned the values 1, 2, 3, and 4 that coincide with corner indices as describe above in relation to FIG. 11. The x and y coordinates of three of the four feature positions P_{Corner}_{_{—}}_{index}, referred to as P_{Corner}_{_{—}}_{index}_{_{—}}x and P_{Corner}_{_{—}}_{index}_{_{—}}y, respectively, are determined according to following eight conditions:

(1) If selected corner feature F₁ is a corner feature of lattice L₁, then
P₁_{_{—}}x=F₁_{_{—}}x, and
P₁_{_{—}}y=F₁_{_{—}}y.

(2) If selected corner feature F₁ is a corner feature of lattice L₂, then
P₁_{_{—}}x=L₁C₁_{_{—}}x, and
P₁_{_{—}}y=L₁C₁_{_{—}}y.

(3) If selected corner feature F₂ is a corner feature of lattice L₁, then
P₂_{_{—}}x=L₁C₂_{₁₃} x, and
P₂_{_{—}}y=F₂_{_{—}}y.

(4) If selected corner feature F₂ is a corner feature of lattice L₂, then
P₂_{_{—}}x=F₂_{_{—}}x, and
P₂_{_{—}}y=L₁C₂_{_{—}}y

(5) If selected corner feature F₃ is a corner feature of lattice L₁, then
P₃_{_{—}}x=F₃_{_{—}}x, and
P₃_{_{—}}y=F₃_{_{—}}y.

(6) If selected corner feature F₃ is a corner feature of lattice L₂, then
P₃_{_{—}}x=L₂C₃_{_{—}}x, and
P₃_{_{—}}y=L₂C₃_{_{—}}y.

(7) If selected corner feature F₄ is a corner feature of lattice L₁, then
P₄_{_{—}}x=F₄_{_{—x}}, and
P₄_{_{—}}y=L₂C₄_{_{—}}y.

(8) If selected corner feature F₄ is a corner feature of lattice L₂, then
P₄_{_{—}}x=L₁C₄_{_{—}}x, and
P₄_{_{—}}y=F₄_{_{—}}y.

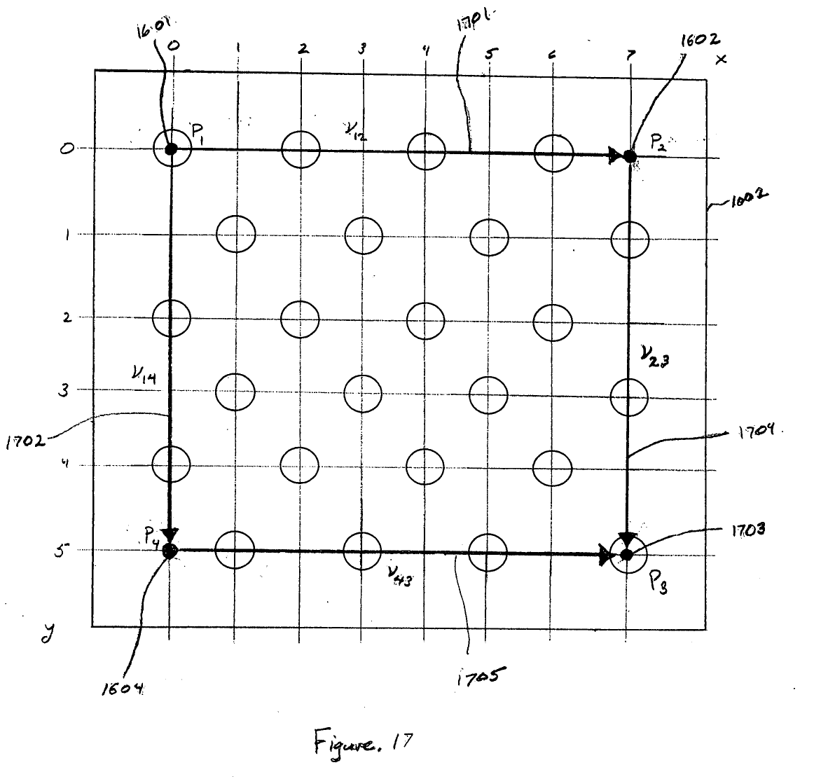

FIG. 16 is an illustration of three of the four feature positions defining the rectilinear, outermost, feature-position arrangement for the hypothetical microarray 1002. Because selected corner feature F₁ 1202 is a corner feature of lattice L₂ 1102, then, according to the condition (2), the feature position P₁ 1601 is assigned the x and y coordinate values of the point L₁C₁, respectively. Because selected corner feature F₂ 1203 is a corner feature of lattice L₂ 1102, then, according to the condition (4), the feature position P₂ 1602 is assigned the x coordinate of selected corner feature F₂ and the y coordinate of point L₁C₂. Finally, because selected corner feature F₃ 1201 is a corner feature of lattice L₂ 1102, then, according to condition (8), the feature position P₂ 1604 is assigned the x coordinate of point L₁C₄ and the y coordinate of selected corner feature F₄.

The three feature positions P₁ 1601, P₂ 1602, and P₄ 1604 define two vectors v₁₂ and v₁₄ given by:
v₁₂=P₂−P₁=<7,0>
v₁₄=₄−P₁=<0,5>
where the brackets “<>” represent vector coordinates. FIG. 17 is an illustration of the two vectors v₁₂ 1701 and v₁₄ 1702 defining a rectilinear, outermost, feature-position arrangement of the hypothetical microarray 1002. The vectors v₁₂ 1701 and v₁₄ 1702 are orthogonal vectors in the feature-coordinate grid as verified by the scalar product given by:
v₁₂·v₁₄=<7,0>·<0,5>=0
Because a vector is a directed line segment having an initial point and an ending point, the line segments associated with the two vectors v₁₂ 1701 and v₁₄ 1702 form two sides of the derived, rectilinear, outermost, feature-position arrangement of the microarray.

The fourth feature position completing the derived, rectilinear, outermost, feature-position arrangement of the microarray is determined according to the following four conditions:

(1) If the feature positions P₁, P₂, and P₃ are known, then
P₄_{_{—}}x=P₁_{_{—}}x
P₄_{_{—}}y=P₃_{_{—}}y

(2) If the feature positions P₂, P₃, and P₄ are known, then
P₁_{_{—}}x=P₄_{_{—}}x
P₁_{_{—}}y=P₂_{_{—}}y

(3) If the feature positions P₁, P₃, and P₄ are known, then
P₂_{_{—}}x=P₃_{_{—}}x
P₂_{_{—}}y=P₁_{_{—y}}

(4) If the feature positions P₁, P₂, and P₄ are known, then
P₃_{_{—}}x=P₂_{_{—}}x
P₃_{_{—}}y=P₄_{_{—}}y

In FIG. 17, the fourth feature position P₃ 1703 of the hypothetical microarray 1002 is determined according to condition (4). The three feature positions P₂ 1602, P_{3,} 1703, and P₄ 1604 define the orthogonal vectors v₂₃ 1704 and v₄₃ 1705 given by:
v₂₃=P₃−P₂=<0,5>
v₄₃=P₃−P₄=<7,0>
where v₁₂·v₄₃=0
The vector v₂₃ 1704 is orthogonal to the vector v₁₂ 1701, and the vector v₄₃ 1705 is orthogonal to the vector v₁₄ 1702. The line segments associated with the vectors v₂₃ 1704 and V₄₃ 1705 provide the two remaining sides of a rectilinear, outermost, feature-position arrangement of the microarray 1002. Finally, the two feature positions P₂ 1602 and P₄ 1604 are added as imaginary features to the non-rectilinear, outermost, feature-position arrangement to give a rectilinear, outermost, feature-position arrangement of the hypothetical microarray 1002.

The C-like pseudo code implementation showing an embodiment of the present invention is provided below. Note that the pseudo code implementation is not intended to describe a complete rectilinearization program for the microarray feature data, but to provide sufficient detail to illustrate one possible embodiment of the rectilinearization methodology as the embodiment might occur within a microarray feature extraction program or in microarray feature extraction and data processing equipment. The rectilinearization program utilizes a feature-coordinate grid similar to that described above in relation to FIG. 13 to produce a derived, outermost, rectilinear feature-position arrangement of the microarray feature data positions that are stored in a computer-readable medium, transferred to an intercommunicating entity via electronic signals, printed in human-readable format, or otherwise made available for further use.

First, the pseudocode implementation includes several constants:
1 const int offset_x;
2 const int offset_y;
3 const int M;
4 const int N;
   The constants “offset_x” and “offset_y” describe the spacing between the vertical and horizontal grid lines, respectively, as described above in relation to FIG. 13. The constants “M” and “N” describes the number of horizontal grid lines, and vertical grid lines. The specific values for the constants depend on the particular microarray image being analyzed.

Next, the pseudocode implementation includes the structure “xy_coord” provided below:

| | |
|---|---|
| 1 | struct xy_coord |
| 2 | { |
| 3 | int x; |
| 4 | int y; |
| 5 | }; |

The variables “x” and “y” are the rectangular Cartesian x and y coordinates used to describe coordinate locations in the feature-coordinate grid as described above in relation to FIG. 13.

Next, the pseudocode implementation contains the two function prototypes:

| | |
|---|---|
| 1 | void corner_vertices(xy_coord *f,xy_coord *p); |
| 2 | void fourth_point(xy_coord *p,int *ci); |

The functions “corner_vertices” are “fourth_point” are identified as void functions. The function “corner_vertices” expects the structure pointers “f” and “p” as arguments. The function “fourth_point” expects the structure pointer “p” and the pointer “ci” as arguments.

The function “corner_vertices” contains the code relevant to one embodiment of the present invention. An implementation of the function “corner_vertices” is provided below:

| | |
|---|---|
| 1 | void corner_vertices(xy_coord *f,xy_coord *p) |
| 2 | { |
| 3 | int latt1_corn_x,latt1_corn_y; |
| 4 | int latt2_corn_x,latt2_corn_y; |
| 5 | int corner_index; |
| 6 | int c_i[4]={0,0,0,0}; |
| 7 | int *ci=c_i; |
| 8 | int exist1,exist2; |
| 9 | |
| 10 | for (int i=0;i<=2;i++) |
| 11 | { |
| 12 | if(0 <= f->x && f->x <= 2) |
| 13 | if(0 <= f->y && f->y <= 2) |
| 14 | { |
| 15 | corner_index = 1; |
| 16 | c_i[0] = 1; |
| 17 | } |
| 18 | if(N−2 <= f->x && f->x <= N) |
| 19 | if(0 <= f->y && f->y <= 2) |
| 20 | { |
| 21 | corner_index = 2; |
| 22 | c_i[1] = 1; |
| 23 | } |
| 24 | if(N−2 <= f->x && f->x <= N) |
| 25 | if(M−2 <= f->y && f->y <= M) |
| 26 | { |
| 27 | corner_index = 3; |
| 28 | c_i[2] = 1; |
| 29 | } |
| 30 | if(0 <= f->x && f->x <= 2) |
| 31 | if(M−2 <= f->y && f->y <= M) |
| 32 | { |
| 33 | corner_index = 4; |
| 34 | c_i[3] = 1; |
| 35 | } |
| 36 | |
| 37 | latt1_corn_x = f->x − offset_x; |
| 38 | latt1_corn_y = f->y − offset_y; |
| 39 | latt2_corn_x = f->x + offset_x; |
| 40 | latt2_corn_y = f->y + offset_y; |
| 41 | |
| 42 | exist1=0; |
| 43 | exist2=0; |
| 44 | if (latt1_corn_x >= 0 && latt1_corn_x <= N) |
| 45 | { |
| 46 | if (latt1_corn_y >= 0 && latt1_corn_y <= M) |
| 47 | exist1=1; |
| 48 | } |
| 49 | if (latt2_corn_x >= 0 && latt2_corn_x <= N) |
| 50 | { |
| 51 | if (latt2_corn_y >= 0 && latt2_corn_y <= M) |
| 52 | exist2=1; |
| 53 | } |
| 54 | |
| 55 | if (corner_index == 1) |
| 56 | { |
| 57 | if (exist1 == 0 && exist2 == 1) |
| 58 | { |
| 59 | p->x = f->x; |
| 60 | p->y = f->y; |
| 61 | } |
| 62 | if (exist1 == 1 && exist2 == 1) |
| 63 | { |
| 64 | p->x = latt1_corn_x; |
| 65 | p->y = latt1_corn_y; |
| 66 | } |
| 67 | } |
| 68 | if (corner_index == 2) |
| 69 | { |
| 70 | p = p + 1; |
| 71 | if (exist1 == 0 && exist2 == 1) |
| 72 | { |
| 73 | p->x = latt2_corn_x; |
| 74 | p->y = f->y; |
| 75 | } |
| 76 | if (exist1 == 1 && exist2 == 0) |
| 77 | { |
| 78 | p->x = f->x; |
| 79 | p->y = latt1_corn_y; |
| 80 | } |
| 81 | p = p − 1; |
| 82 | } |
| 83 | if (corner_index == 3) |
| 84 | { |
| 85 | p = p + 2; |
| 86 | if (exist1 == 1 && exist2 == 0) |
| 87 | { |
| 88 | p->x = f->x; |
| 89 | p->y = f->y; |
| 90 | } |
| 91 | if (exist1 == 1 && exist2 == 1) |
| 92 | { |
| 93 | p->x = latt2_corn_x; |
| 94 | p->y = latt2_corn_y; |
| 95 | } |
| 96 | p = p − 2; |
| 97 | } |
| 98 | if (corner_index == 4) |
| 99 | { |
| 100 | p = p + 3; |
| 101 | if (exist1 == 0 && exist2 == 1) |
| 102 | { |
| 103 | p->x = f->x; |
| 104 | p->y = latt2_corn_y; |
| 105 | } |
| 106 | if (exist1 == 1 && exist2 == 0) |
| 107 | { |
| 108 | p->x = latt1_corn_x; |
| 109 | p->y = f->y; |
| 110 | } |
| 111 | p = p − 3; |
| 112 | } |
| 113 | f++; |
| 114 | } |
| 115 | fourth_point(p,ci); |
| 116 | } |

The function “corner_vertices” takes the following arguments: (1) “f,” a pointer to the structure elements F_{Corner}_{_{—}}_{index} x and F_{Corner}_{_{—}}_{index}_{_{—}}y of the array holding the three selected corner features F_{Corner}_{_{—}}_{index}; and (2) “p,” a pointer to the structure elements P_{Corner}_{_{—}}_{index}_{_{—}}x and P_{Corner}_{_{—}}_{index}_{_{—}}y of the array holding the feature positions P_{Corner}_{_{—}}_{index}. On lines 3-8, a number of local variables are declared. These local variables include: (1) “latt1_corn_x,” “latt1_corn_y,” “latt2_corn_x,” and “latt2_corn_y,” the x and y coordinates of the points L₁C_{Corner}_{_{—}}_{index} and L₂C_{Corner}_{_{—}}_{index}, respectively, as defined above in equations (1)-(4); (2) “corner_index,” the index of the corner feature of lattices L₁ and L₂ as described above in relation to the hypothetical example shown in FIG. 11; (3) “c_i,” a four-element array, where the element of “c_i” having the value “0” identifies the corner point to be determined in the function “fourth_point;” (4) “ci,” a pointer to the elements of array “c_i;” and (5) “exist1” and “exist2,” variables used to determine whether or not the two points L₁C_{Corner}_{_{—}}_{index} and L₂C_{Corner}_{_{—}}_{index} coincide with features of the microarray. In the for-loop of line 10, lines 11-114 are repeated for each of the three selected corner features to determine the x and y coordinates of three of the feature positions P_{Corner}_{_{—}}_{index}. On lines 12 and 13, if the selected corner feature is located in the top, left-hand corner of either lattice L₁ or L₂, as described above in relation to FIG. 11, then on line 15, “corner_index” is assigned the value “1,” and on line 16, the first element of “c_i” is assigned the value “1.” On lines 12 and 13, if the selected corner feature is not located in the top, left-hand corner of either lattice L₁ or L₂, then the program proceeds to line 18. On lines 18-35, an analogous procedure to that of lines 12-17 is carried out to determine the value of “corner_index” and the elements of the array “c_i.” On lines 37-40, “latt1_corn_x,” “latt1_corn_y,” “latt2_corn_x,” and “latt2_corn_y” are calculated, respectively. On lines 42 and 43, “exist1” and “exist2” are both assigned the value “0.” On lines 44 and 46, if the point L₁C_{Corner}_{_{—}}_{index} coincides with a feature of the microarray, then on line 47, “exist1” is assigned the value “1.” On lines 49 and 51, if the point L₂C_{Corner}_{_{—}}_{index} coincides with a feature of the microarray, then on line 52, “exist2” is assigned the value “1.” In the nested if-statements of lines 55-112, the x and y coordinates of three of the four derived, outermost feature positions P₁, P₂, P₃, and P₄ are determined according to the conditions 1-8, as described above in relation to FIG. 16. On line 55, if “corner_index” equals “1,” then lines 57 and 62 are executed. On lines 59 and 60, P₁x and P₁_{_{—}}y are assigned the coordinate values F₁_{_{—}}x and F₁y, respectively, if the value of “exist1” is “0,” and the value of “exist2” is “1” on line 57. On lines 64 and 65, P₁_{_{—}}x and P₁_{_{—}}y are assigned the coordinate values L₁C₁_{_{—}}x and L₁C₁_{_{—}}y, respectively, if the value of “exist1” is “1,” and the value of “exist2” is “1” on line 62. On lines 68-82, an analogous procedure to that of lines 55-67 is carried out to determine the structure elements P₂_{_{—}}x and P₂_{_{—}}y. On lines 83-97, an analogous procedure to that of lines 55-67 is carried out to determine the structure elements P₃_{_{—}}x and P₃_{_{—}}y. On lines 98-112, an analogous procedure to that of lines 55-67 is carried out to determine the structure elements P₄_{_{—}}x and P₄_{_{—}}y. On line 113, “f” is incremented. On line 115, the function “fourth_point” is called.

The function “fourth_point” contains the code relevant to one embodiment of the present invention. An implementation of the function “fourth_Point” is provided below:

| | |
|---|---|
| 1 | void fourth_point(xy_coord *p,int *ci) |
| 2 | { |
| 3 | int temp_x; |
| 4 | int temp_y; |
| 5 | if (*ci == 0) |
| 6 | { |
| 7 | p = p + 3; |
| 8 | temp_x = p->x; |
| 9 | p = p − 2; |
| 10 | temp_y = p->y; |
| 11 | p = p − 1; |
| 12 | p->x = temp_x; |
| 13 | p->y = temp_y; |
| 14 | return; |
| 15 | } |
| 16 | ci++; |
| 17 | if (*ci == 0) |
| 18 | { |
| 19 | p = p + 2; |
| 20 | temp_x = p->x; |
| 21 | p = p − 2; |
| 22 | temp_y = p->y; |
| 23 | p = p + 1; |
| 24 | p->x = temp_x; |
| 25 | p->y = temp_y; |
| 26 | return; |
| 27 | } |
| 28 | ci++; |
| 29 | if (*ci == 0) |
| 30 | { |
| 31 | p = p + 1; |
| 32 | temp_x = p->x; |
| 33 | p = p + 2; |
| 34 | temp_y = p->y; |
| 35 | p = p − 1; |
| 36 | p->x = temp_x; |
| 37 | p->y = temp_y; |
| 38 | return; |
| 39 | } |
| 40 | ci++; |
| 41 | if (*ci == 0) |
| 42 | { |
| 43 | temp_x = p->x; |
| 44 | p = p + 2; |
| 45 | temp_y = p->y; |
| 46 | p = p + 1; |
| 47 | p->x = temp_x; |
| 48 | p->y = temp_y; |
| 49 | return; |
| 50 | } |
| 51 | } |

The function “fourth_point” takes the following arguments: (1) “p,” a pointer to the structure elements P_{Corner}_{_{—}}_{index}_x and P_{Corner}_{_{—}}_{index}_y of the array holding the four, outermost feature positions P₁, P₂, P₃, and P₄ defining a rectilinear, outermost feature-position arrangement of the microarray; and (2) “ci,” a pointer to the elements of the array “c_i.” On lines 3 and 4, two local variables are declared. These local variables include: “temp_x” and “temp_y,” variables that hold the x and y coordinate values. If the fourth, outermost feature position to be determined is P₁, then lines 5-15 are executed to determine P₁_{_{—}}x and P₁_{_{—}}y according to condition 1, as described above in relation to FIG. 17. On line 5, if the first element of “c_i” is “0,” then lines 7-14 are executed. On line 7, “p” points to the structure element holding the values P₄_{_{—}}x and P₄_{_{—}}y. On line 8, “temp_x” is assigned the value of P₄_{_{—}}x. On line 9, “p” points to the structure element holding the values P₂_{_{—}}x and P₂_{_{—}}y. On line 10, “temp_y” is assigned the value of P₂_{_{—}}y. On line 11, “p” points to the structure element holding the values P₁_{_{—}}x and P₁_{_{—}}y. On lines 12 and 13, P₁_{_{—}}x and P₁_{_{—}}y are assigned the values stored in “temp_x” and “temp_y,” respectively. On line 14, the program returns to the calling function “corner_vertices.” On line 5, if the first element of array “c_i” is “1,” then the program skips lines 6-15. On line 16, “ci” is incremented. On lines 17-27, an analogous procedure to that of lines 5-16 is carried out to determine the structure elements P₂_{_{—}}x and P₂_{_{—}}y, if the fourth, outermost feature position to be determined is P₂. On lines 29-39, an analogous procedure to that of lines 5-16 is carried out to determine the structure elements P₃_{_{—}}x and P₃_{_{—}}y, if the fourth, outermost feature position to be determined is P₃. On lines 41-50, an analogous procedure to that of lines 5-16 is carried out to determine the structure elements P₄_{_{—}}x and P₄_{_{—}}y, if the fourth, outermost feature position to be determined is P₄.

Although the present invention has been described in terms of a particular embodiment, it is not intended that the invention be limited to this embodiment. Modifications within the spirit of the invention will be apparent to those skilled in the art. For example, an almost limitless number of different implementations of the many possible embodiments of the method of the present invention can be written in any of many different programming languages, embodied in firmware, embodied in hardware circuitry, or embodied in a combination of one or more of the firmware, hardware, or software, for inclusion in microarray data processing equipment employing a computational processing engine to execute software or firmware instructions encoding techniques of the present invention or including logic circuits that embody both a processing engine and instructions. In various embodiments of the present invention, the process of selecting corner features can be performed automatically by a computer program, or the corner features can be selected manually. In various embodiments, the selected corner features can be ordered in various ways such as in a clockwise or counter-clockwise manner beginning with any one of the four corners of the microarray. In various embodiments, different orderings of the corner features may be employed. In various embodiments, different possible selected corner features may be considered.

The foregoing description, for purposes of explanation, used specific nomenclature to provide a thorough understanding of the invention. However, it will be apparent to one skilled in the art that the specific details are not required in order to practice the invention. The foregoing description of specific embodiments of the present invention are presented for purposes of illustration and description. They are not intended to be exhaustive or to limit the invention to the precise forms disclosed. Obviously many modifications and variations are possible in view of the above teachings. The embodiments are shown and described in order to best explain the of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for rectilinearizing image data from a microarray comprising a double-density, non-rectilinear set of microarray features having a non-rectilinear, outermost, feature position arrangement, the method comprising:
constructing a feature-coordinate system to determine feature positions in the image data; and
based on the determined feature positions, adding one or more imaginary feature positions to the non-rectilinear, outermost, feature-position arrangement to form a rectilinear, outermost, feature-position arrangement of the microarray features.

2. The method of claim 1 further includes orienting the image of the microarray so that a corner feature is located in the top, left-hand corner of the image of the microarray, and a corner feature is located in the bottom, right-hand corner of the image of the microarray.

3. The method of claim 1 wherein constructing the feature coordinate system further includes superimposing horizontal and vertical grid lines onto the image so that each feature of the microarray is located at a unique intersection of the horizontal and vertical grid lines.

4. The method of claim 1 wherein adding one or more feature positions further includes:
selecting three corner-feature positions of microarray features; and
determining four feature positions that provide the four feature corners of a rectilinear, outermost, feature-position arrangement of the image of microarray features based on the three corner-feature positions.

5. The method of claim 4 wherein selecting the three corner features further includes selecting the three corner features automatically using a computer program.

6. The method of claim 4 wherein selecting the three corner features further includes selecting the three corner features manually.

7. The method of claim 4 determining the four feature positions further includes:
partitioning the microarray having a non-rectilinear, outermost, feature-position arrangement into a first lattice having a rectilinear, outermost, feature-position arrangement and a second lattice having rectilinear, outermost, feature-position arrangement; and
determining whether a selected corner-feature position is a corner-feature position in the first lattice or a corner-feature position in the second lattice for each of the three selected corner-feature positions.

8. The method of claim 7 wherein determining four feature positions further includes determining the one or more feature positions defining the rectilinear, outermost, feature-position arrangement of the microarray of features based on the determination of whether each of the three selected corner-feature positions belong to the first lattice or the second lattice.

9. Transferring results produced by a microarray scanner or microarray data processing program employing the method of claim 1 stored in a computer-readable medium to an intercommunicating entity.

10. Transferring results produced by a microarray scanner or microarray data processing program employing the method of claim 1 to an intercommunicating entity via electronic signals.

11. A computer program including an implementation of the method of claim 1 stored in a computer-readable medium.

12. A method comprising forwarding data produced by using the method of claim 1.

13. A method comprising receiving data produced by using the method of claim 1.

14. A microarray scanner that employs the method of claim 1 to rectilinearize a set of microarray features having a non-rectilinear, outermost, feature-position arrangement.

15. A system for processing a multi-channel, double-density, non-rectilinear set of microarray features data set, the system comprising:
a computer processor;
one or more memory components that store microarray feature data points; and
a stored program executed by the computer processor that constructs a feature-coordinate system to provide feature positions, and adds one or more imaginary feature positions to the non-rectilinear, outermost, feature-position arrangement to form a rectilinear, outermost, feature-position arrangement of the microarray features.

16. The system of claim 15 wherein constructs the feature coordinate system further includes superimposition of horizontal and vertical grid lines onto the image so that each feature of the microarray is located at a unique intersection of the horizontal and vertical grid lines.

17. The system of claim 15 wherein adds one or more feature positions further includes:
selects three corner-feature positions of microarray features; and
determines four feature positions that provide the four feature corners of a rectilinear, outermost, feature-position arrangement of the image of microarray features based on the three corner-feature positions.

18. The system of claim 15 determines the four feature positions further includes:
partitions the microarray having a non-rectilinear, outermost, feature-position arrangement into a first lattice having a rectilinear, outermost, feature-position arrangement and a second lattice having rectilinear, outermost, feature-position arrangement; and
determines whether a selected corner-feature position is a corner-feature position in the first lattice or a corner-feature position in the second lattice for each of the three selected corner-feature positions.

19. The system of claim 18 wherein determines four feature positions further includes determination of the one or more feature positions defining the rectilinear, outermost, feature-position arrangement of the microarray of features based on the whether each of the three selected corner-feature positions belongs to the first lattice or the second lattice.
